(19) United States
(12) Patent Application Publication
(10) Pub. No.: US 2026/0100593 A1
(43) Pub. Date: Apr. 9, 2026

(54) CONTROL SYSTEM AND METHOD FOR DC AUGMENTATION OF BATTERY ENERGY STORAGE SYSTEMS

(71) Applicant: AES Clean Energy Services, LLC, Salt Lake City, UT (US)

(72) Inventors: Michael Simpson, Centennial, CO (US); Kelsey Horowitz, Louisville, CO (US)

(73) Assignee: AES Clean Energy Services, LLC, Salt Lake City, UT (US)

(21) Appl. No.: 19/349,113

(22) Filed: Oct. 3, 2025

Related U.S. Application Data
(60) Provisional application No. 63/705,225, filed on Oct. 9, 2024.

(51) Int. Cl. H02J 7/34; H02J 3/32; H02J 7/00

(52) U.S. Cl. CPC H02J 7/342; H02J 3/32; H02J 7/94; H02J 2207/20

(57) ABSTRACT

A power storage system and method for operating a power storage system. The power storage system may include a legacy battery energy storage system (BESS) module that may degrade over time. In order to compensate for the degrade of the legacy BESS, a supplemental BESS module along with DC-to-DC converter/controller circuitry are installed. In practice, a PCS may control the power drawn, with the supplemental BESS module sensing and providing the power, effectively following the control as dictated by the PCS. In this way, the supplemental BESS may be used in conjunction with the legacy BESS to reduce the effects of the degradation of the legacy PCS without the PCS even being able to detect the supplemental BESS.

### REFERENCE TO RELATED APPLICATION

The present application claims priority benefit to U.S. Provisional Application No. 63/705,225 (filed on Oct. 9, 2024), which is incorporated by reference herein in its entirety.

### FIELD OF THE INVENTION

The present application relates generally to the field of control of batteries. Specifically, the disclosure relates to a control system and method for DC augmentation of one or more Battery Energy Storage Systems (BESS).

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Batteries, such as a BESS, may be used in a variety of contexts, including with renewables, residential or commercial applications, a grid (e.g., a macrogrid, such as a utility grid, or a microgrid), industrial loads, or the like. As one example, the BESS may capture energy from renewables (e.g., solar panels) for use at a later time (e.g., at night when the solar panels do not generate energy). As another example, the BESS may provide power to the grid, such as by balancing fluctuating demand while reducing grid overload.

As the batteries in the BESS age, the batteries'capacity may fade or may fail entirely. To maintain a given level of service, augmentation (or the addition of new energy storage) may be performed.

### SUMMARY

In one or some embodiments, a power storage system is disclosed. The power storage system includes: a legacy battery energy storage system (BESS) module, the legacy BESS module including at least one battery and at least one output terminal electrically connected to at least one power bus; a supplemental BESS module configured to supplement power to the at least one power bus, the supplemental BESS module including at least one supplemental battery and at least one output terminal; at least one converter electrically coupled between the at least one output terminal of the supplemental BESS module and the at least one power bus; and at least one controller. The at least one controller configured to: determine at least one electrical parameter set by at least one power control system (PCS) for the at least one power bus; and control the at least one converter in order to generate at least one output based on the at least one electrical parameter set on the at least one power bus set by the at least one PCS.

In one or some embodiments, a method for supplying power from a legacy battery energy storage system (BESS) module and a supplemental BESS module that is later-installed than the legacy BESS module is disclosed. The legacy BESS module includes at least one battery and at least one output terminal electrically connected to at least one power bus, and the supplemental BESS module includes at least one supplemental battery and at least one output terminal. The method comprises: determining at least one electrical parameter set by at least one power control system (PCS) for the at least one power bus; and control at least one converter in order to generate at least one output based on the at least one electrical parameter set on the at least one power bus set by the at least one PCS, the at least one converter electrically coupled between the at least one output terminal of the supplemental BESS module and the at least one power bus.

In one or some embodiments, a method for supplementing power from a legacy battery energy storage system (BESS) module with a supplemental BESS module that is later-installed than the legacy BESS module is disclosed. The legacy BESS module includes at least one battery and at least one output terminal electrically connected to at least one power bus, and the supplemental BESS module include at least one supplemental battery and at least one output terminal. The method comprises: accessing one or more metrics; determining, based on the one or more metrics, whether to supplement the legacy BESS module with the supplemental BESS module; and responsive to determining to supplement the legacy BESS module with the supplemental BESS module, supplementing the legacy BESS module with the supplemental BESS module so that the supplemental BESS module augments power generated by the legacy BESS module to at least one PCS without the at least one PCS being able to detect the supplemental BESS module after electrical connection of the supplemental BESS module to the at least one power bus and after the supplemental BESS module provides power to the at least one power bus.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is an example block diagram illustrating a high-level system architecture for supplying power to a load, such as via a plurality of power sources, including solar and battery power.

FIG. 2 is an example block diagram for a legacy battery power system that is configured to supply power to a load.

FIG. 3A is a first example block diagram for supplementing a legacy battery power system with a supplemental battery power system.

FIG. 3B is a second example block diagram for supplementing a legacy battery power system with a supplemental battery power system.

FIG. 3C is a third example block diagram for supplementing a legacy battery power system with a supplemental battery power system.

FIG. 3D is a fourth example block diagram for supplementing a legacy battery power system with a supplemental battery power system.

FIG. 4A is an example flow diagram for determining when to supplement with one or more supplemental battery power systems.

FIG. 4B is an example flow diagram for operating the legacy battery power system and the supplemental battery power system(s).

FIG. 5 is a graph of power supplied versus time.

FIG. 6 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, a BESS may be used to source and/or store power in a variety of contexts. Further, the BESS may be in a variety of configurations. As one example, the batteries, such as part of the BESS, may be in the form of one or more strings of batteries (e.g., one or more batteries serially connected to one another). Further, the strings of batteries may be connected in parallel to one another. As discussed in more detail below, the one or more strings of batteries may be individually controlled (e.g., one, some or each string may be operated individually).

Over time, the batteries in the BESS may age, as discussed in the background. Battery capacity loss over time is to be expected. For example, the batteries, over time, may provide less power. Typically, the current provided by the batteries may not change over time; however, the overall power and energy may degrade. Further, the batteries in the various strings may degrade at different rates, such as due to usage (e.g., rate of charging/discharging) and/or due to manufacturing flaws. Nevertheless, the battery system, such as the BESS, may need to maintain a given level of service (e.g., the battery system provides a predetermined amount of power, voltage, etc.).

One option to maintain the given level of service to compensate for battery capacity loss in a legacy battery system is replacement. For example, the batteries in the various strings (e.g., in the legacy battery system) may simply be replaced or swapped out. However, this solution may be problematic for several reasons. First, the product manufacturing life for batteries is typically two years, meaning that after two years, it may be difficult to obtain a same-product replacement battery. Second, even if the same battery is available, when the batteries'capacity degrades, the system operates at different voltages. As such, simply swapping batteries may be problematic since the new battery(ies) and the old battery(ies) may operate at different voltages, causing balancing or short circuit problems. More specifically, adding a new battery to an existing battery bus may limit the total usable capacity of one or the other as voltages need to match to prevent faults.

Another option is to add new strings to the battery configuration, effectively adding a new inverter and new batteries (e.g., “AC Augmentation”). Again, the legacy battery bank may operate at a lower capacity over time. However, adding an entirely new power block (e.g., battery+inverter+transformer) may be prohibitively expensive or may even be forbidden by the interconnection authority. For example, the utility managing the grid may require coordination, such as a new interconnection agreement, thereby complicating the process.

Still another option is “DC Augmentation”. In particular, in one or some embodiments, a legacy BESS may be supplemented with a supplemental BESS by using at least one converter and at least one controller, whereby the at least one controller is configured to: determine at least one electrical parameter set by at least one power control system (PCS) for power bus(es); and control the at least one converter in order to generate at least one output based on the at least one electrical parameter set on the power bus(s) set by the at least one PCS. For example, the electrical parameter may comprise the current on the power bus(es) (e.g., the current and/or voltage provided by the legacy BESS), with the at least one controller is configured to control the at least one converter in order to generate at least one output current based on the current on the at least one power bus set by the at least one PCS and a voltage that follows a voltage on the at least one power bus. Thus, the supplemental BESS may be added (and sized) in order to, at least in part, accommodate the degrading of the legacy BESS.

Various ways are contemplated to determine the at least one electrical parameter set by the PCS. In one way, one or more sensors may be used to sense the at least one electrical parameter (e.g., sense the current on the power bus). Alternatively, or in addition, the controller may communicate with the PCS to determine the at least one electrical parameter (e.g., the current) set on the power bus.

Further, the controller may control the converter in order to generate at least one output based on at least one electrical parameter in one of several ways. In one way, the controller may control the converter to generate the output (e.g., the output current) to be proportional to the current on the power bus. Alternatively, or in addition, the controller may control the converter to generate the output in a dynamic manner (e.g., dynamically control the at least one converter to generate the at least one output current so that, over time, the at least one controller controls at least one output current to be a different proportion of the sensed current).

In this way, the supplemental BESS may be used in conjunction with the legacy BESS. Further, in one or some embodiments, certain hardware, such as the PCS, need not even be able to detect the supplemental BESS. In particular, in one or some embodiments, the PCS may be unable to detect the supplemental BESS module even after electrical connection of the supplemental BESS module to the at least one power bus and after the supplemental BESS module provides power to the at least one power bus. Thus, even with a constrained system, in which it may be difficult to implement a change, such as due to approval by the utility (which may control the PCS), the supplemental BESS module may provide the fix needed due to the degrading legacy BESS module. In this regard, the supplemental BESS provides the power needed without upending the legacy BESS system.

For example, in one or some embodiments, the supplemental BESS module is configured to provide DC voltage augmentation. In one or some embodiments, none of the batteries are removed from the legacy BESS module in the augmentation process. Alternatively, at least some of the batteries in the legacy BESS module remain in the augmentation process. In either instance, the supplemental BESS module includes one or more additional batteries and at least one mediator device, with the at least one mediator device configured to present the additional batteries (in the form of the supplemental BESS module) as similar or identical to the legacy BESS module to at least one other device. As discussed below, the controller and/or the converter (e.g., the DC-DC converter) are examples of the at least one mediator device.

In one or some embodiments, the at least one other device may comprise one or more power control systems (PCSs) that work in combination with the legacy BESS module and that are not changed in any one, any combination or all of: perception of devices in which it interacts; wiring; or control. As one example, even after adding the supplemental BESS module, the augmentation is invisible or undetectable to electronic devices upstream, such as to one or both of the load (e.g., the grid) or to upstream electronics (e.g., the PCSs may perceive the additional batteries in the supplemental BESS module as similar or identical to the legacy BESS module). As another example, separate from perception by the PCSs of no perceptible change with regard to power provided by the BESS modules (including one or both of the legacy BESS module or the supplemental BESS module), no additional wiring is necessary with regard to the PCSs (e.g., no mechanical modifications). As such, in one or some embodiments, no changes are required on the grid side, obviating the need to petition for changes in the grid. As yet another example, PCSs control of the BESS module (including one or both of the legacy BESS module or the supplemental BESS module) need not change. In particular, no reprogramming may be necessary when adding the supplemental BESS module since, in one or some embodiments, the supplemental BESS module may take an entirely passive role (e.g., determine the current on the power bus and follow it), effectively following the control of the PCSs, so that the PCSs may continue with the same type of control both pre-and post-supplementation by the supplemental BESS module. In one particular example, the at least one mediator device may passively follow the sensed current based on pre-programming. A first example comprises generating a proportional current to the sensed current, with a proportional integral differential loop being used to maintain a stable voltage in one or more transition states (e.g., stable voltage states and/or transient voltage states). Alternatively, or in addition, a second example comprised generating a dynamically changing current based on the sensed current. Thus, in one or some embodiments, the at least one mediator device in combination with the supplemental BESS module may comprise a lesser intrusion to the system (e.g., with no intrusion on the grid side), thereby presenting as seamless to the hardware on the grid side (e.g., the PCSs) while using hardware for the at least one mediator device (e.g., DC/DC converter(s)) to enable seamless integration between the legacy BESS module and the supplemental BESS module (e.g., from a physical integration and/or a control integration of the legacy BESS module and the supplemental BESS module).

In one or some embodiments, the augmentation may be performed at one or more stages. For example, the legacy batteries may be operated for a designated time, such as upwards of 20 years. Further, the legacy batteries may degrade at various rates over various times. In this regard, the augmentation may be performed at one or more times during the operational life of the legacy BESS module and/or in one or more architectures. In one example, the augmentation may be performed at predetermined times during the operational life of the legacy BESS module. Alternatively, or in addition, the augmentation may be performed based on sensed operation of the legacy BESS module. In particular, responsive to determining that the legacy BESS module has degraded in at least one aspect (e.g., by a predetermined percentage with regard to at least one metric, such as by a predetermined percentage current and/or a predetermined percentage voltage), the augmentation may be performed. Further, with regard to architecture, in one or some embodiments, one, some, or all augmented BESS modules may be independently operated. As discussed in more detail below, a plurality of augmented BESS modules may be added at different times and/or with separate architectures. Two or more of the plurality of augmented BESS modules may each have independent control, such as a respective controller that senses the current on the power bus(es) and that generates the current/voltage responsive thereto for the augmented BESS module under its respective control. Alternatively, one, some, or all of the augmented BESS modules may be dependently operated (e.g., may be under common control). In the given example of the plurality of augmented BESS modules, two or more of the plurality of augmented BESS modules may have dependent control, such as a respective controller that senses the current on the power bus(es) and generates the current/voltage responsive thereto for a plurality of the augmented BESS modules under its control.

Thus, in one or some embodiments, the augmentation may be performed in one or more phases. For example, in a first phase, a first set of BESS module(s) (which may comprise one or more BESS modules in series and/or in parallel) may be electrically incorporated with the legacy BESS module. Further, in a second phase, a second set of BESS module(s) (which may comprise one or more BESS modules in series and/or in parallel) may be electrically incorporated with the legacy BESS module. In one or some embodiments, the second set of BESS module(s) may be electrically integrated with the first set of BESS module(s) (e.g., in series and/or in parallel with the first set of BESS module(s)). Alternatively, or in addition, the second set of BESS module(s) may be electrically segregated from the first set of BESS module(s). Further, in one or some embodiments, part or all of the first set of BESS module(s) is identical to part or all of the second set of BESS module(s) in one or more respects, such as in terms of capacity. Alternatively, or in addition, part or all of the first set of BESS module(s) may be different from part or all of the second set of BESS module(s) in one or more respects, such as different capacity.

Further, in one or some embodiments, the control of the BESS module(s) introduced within a particular stage (e.g., installed at the same time) and/or across different stages (e.g., installed at different points in time) may be common and/or may be separate. As one example, control of multiple BESS modules, installed in a particular phase, may be separate for each of the multiple BESS modules (e.g., a first controller/first converter is assigned to first supplemental BESS module and a second controller/second converter is assigned to second supplemental BESS module). As another example, common control may be used for multiple BESS modules installed in the particular phase (e.g., a common controller/common converter may be assigned to the first supplemental BESS module and to the second supplemental BESS module). As still another example, control of multiple BESS modules, installed in different particular phases, may be separate for each of the multiple BESS modules (e.g., a first controller/first converter is assigned to first supplemental BESS module installed in a first phase and a second controller/second converter is assigned to second supplemental BESS module installed in a second phase that is later in time to the first phase). As yet another example, common control may be used for multiple BESS modules installed in the particular phase (e.g., a common controller/common converter may first be used by the first supplemental BESS module installed in a first phase; the second supplemental BESS module installed in a second phase uses the common controller/common converter as its control). In this regard, the controller may comprise a leading or dominant controller (e.g., for controlling one or more converters) that controls multiple BESS modules (whether the BESS modules are installed at the same time or in different phases).

Separate from common control, the amount of power requested from the supplemental BESS modules may be the same or may be different. As discussed above, in one or some embodiments, the respective controller may control its associated BESS module for a certain proportionality (e.g., a certain percentage of the sensed current). In one or some embodiments, the control of the different BESS modules (whether under common control or not) may be identical (e.g., the same percentage of the sensed current). Alternatively, the control of the different BESS modules (whether under common control or not) may be different (e.g., different percentages of the sensed current for first BESS module(s) and second BESS module(s)).

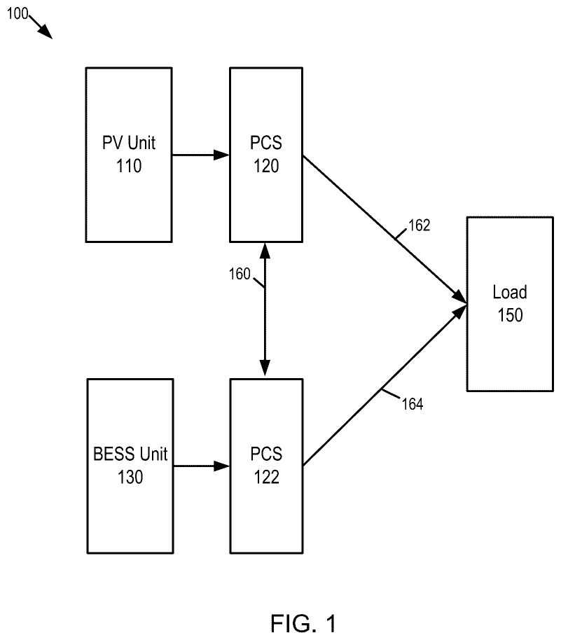

As discussed above, a BESS module may be used in a variety of contexts. In one context, the BESS module is used as a standalone power source and/or power sink. Alternatively, the BESS module may be used in combination with another power source. As one example, the BESS module may be used in combination with solar power generation, such as illustrated in FIG. 1. Specifically, FIG. 1 illustrates an example block diagram illustrating a high-level system architecture 100 for supplying power to a load 150, such as via a plurality of power sources, including solar power (as shown by photovoltaic (PV) unit 110) and battery power (as shown by BESS unit 130).

Further. FIG. 1 illustrates PCSs 120, 122 providing power via 162, 164 to load 150, with communication therebetween via 160. PCSs 120, 122 may generally control the output of one or more power production sources, such as one or both of PV systems, batteries, etc. More specifically, the PCSs 120, 122 may be configured to provide one or more functions, such as performing AC-to-DC conversion and/or DC-to-AC conversion, which may use a bi-directional inverter, limiting power flow from one or more circuits so that the current does not exceed a rating limit.

Thus, FIG. 1 illustrates the high-level system architecture 100 as one example of use of the BESS unit 130. Various uses are contemplated, including uses as part of a macrogrid and/or microgrid. For example, the BESS unit 130 may be part of a system that includes a grid with various hardware, such as one or more substations, transmission lines, etc.

In one or some embodiments, the BESS, which may comprise the BESS unit 130, may comprise one or more rechargeable batteries configured to store energy from one or more sources and discharge energy when needed. Example BESS systems or units are disclosed in US Patent Application Publication No. 2024/0106243 A1, incorporated by reference herein in its entirety. BESS, in combination with control electronics, such as PCS 122, may provide any one, any combination, or all of the following support functions to the power grid: frequency regulation; ancillary services/grid stability (e.g., BESS systems may charge and discharge quickly in order to balance the grid on the demand and/or the production side); voltage support/stabilization; emergency response systems (e.g., BESS systems may provide emergency response services of any one, any combination, or all of frequency regulation, ramping, and voltage support in a manner that is similar to energy reliability services from synchronous facilities); operating reserves; reduction of grid congestion; ramp rate control; energy arbitrage; capacity firming; peak shaving; or black start.

The BESS may include: battery modules (which may comprise BESS unit 130 and which may be connected in series and/or parallel to obtain the required capacity); storage enclosure with thermal management; and either contain or work in conjunction with the PCS 122.

In one or some embodiments, part or all of the BESS and the various other electronics may be stationary. Alternatively, or in addition, part or all of the BESS and the various other electronics may be mobile, such as a mobile plug-and-play BESS whereby at least a part of the system, such as the batteries (e.g., the BESS unit(s) 130 are mobile and may be moved proximate to a part of the grid. The various other electronics, such as any one, any combination, or all of the following may likewise be mobile and may be moved proximate to the grid. As one example, the PCS 122 may be housed within or alongside the BESS unit(s) 130 and thus may be moved along with the BESS unit(s) 130 to a part of the grid. As another example, the PV unit(s) 110 may be mobile and moved along with PCS 120 to be proximate to the part of the grid.

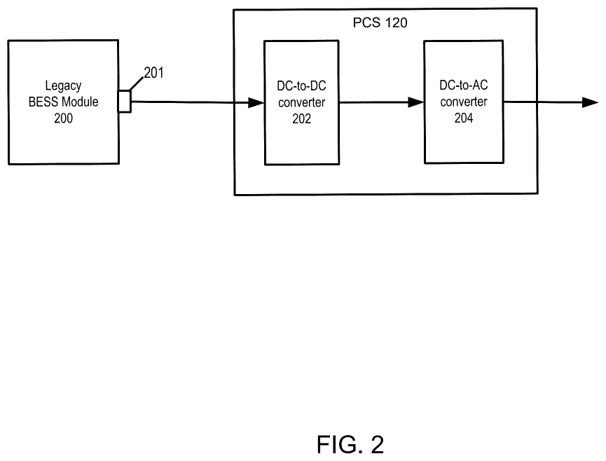

FIG. 2 is an example block diagram for a legacy battery power system that is configured to supply power to a load (such as load 150). Specifically, FIG. 2 illustrates that the legacy battery power system includes a legacy BESS module 200 that may include a plurality of batteries and include at least one output terminal 201 that is electrically connected to a power bus, and PCS 120. FIG. 2 illustrates one example of PCS 120, which may include a DC-to-DC converter 202 and DC-to-AC converter 204. Other implementations of PCS 120 are contemplated.

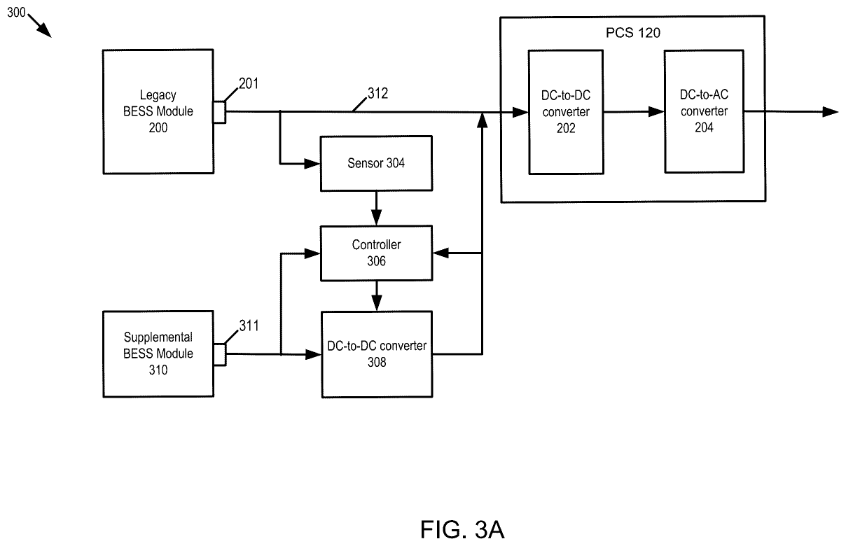

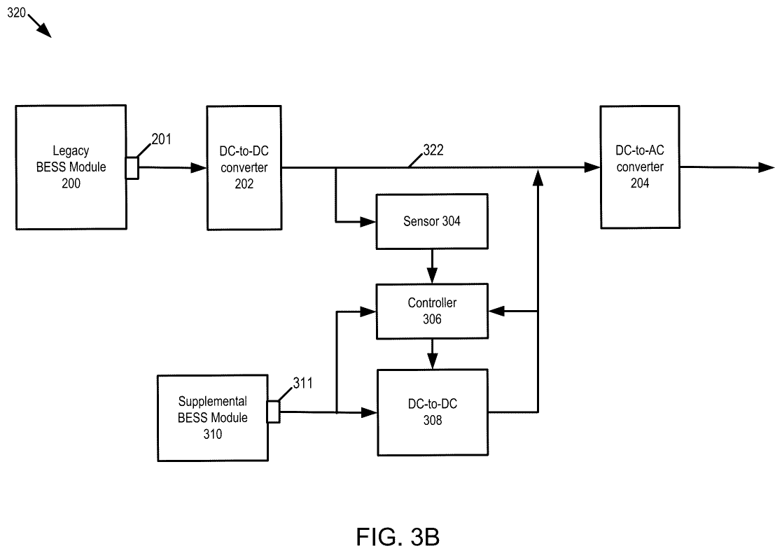

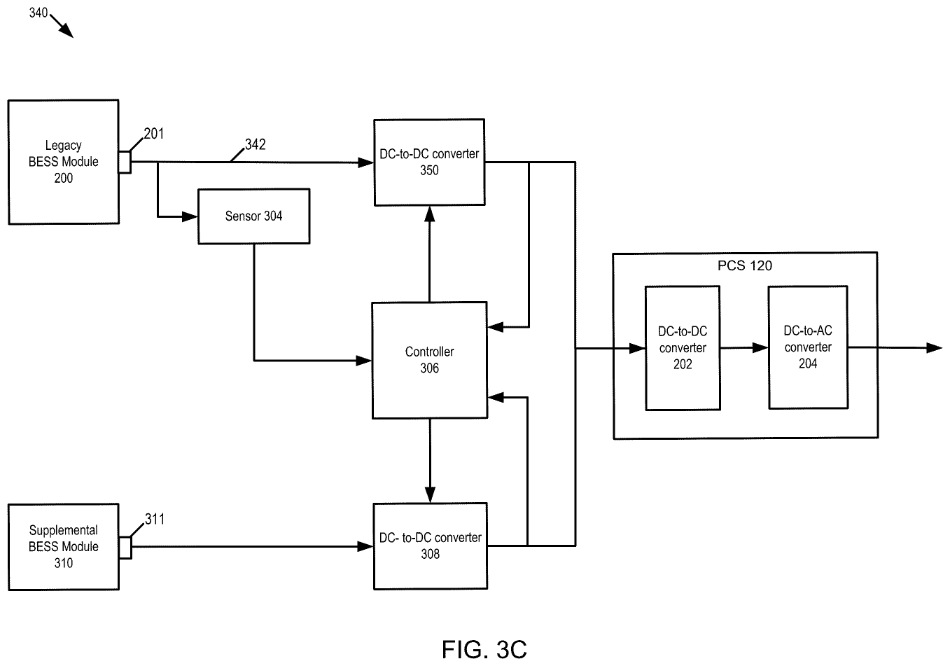

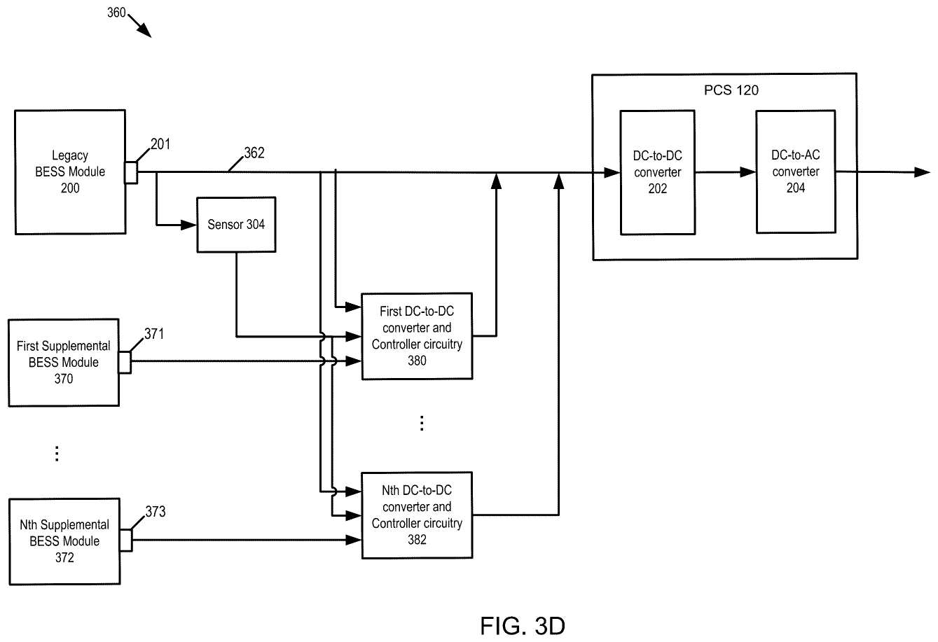

FIGS. 3A-D illustrate different implementations of the supplemental BESS module(s). For example, FIG. 3A is a first example block diagram 300 for supplementing a legacy battery power system (see legacy BESS module 200) with a supplemental battery power system (see supplemental BESS module 210) that is configured to supply supplemental battery capacity. As discussed above, a power bus in one or more parts of the circuit may be sensed. For example, sensor 304 may generate sensor data that is indicative of the sensed one or more aspects (e.g., current and/or voltage) of line 312 input to PCS 120. In one or some embodiments, a single sensor may be used to generate the sensor data (e.g., current and/or voltage on line 312). Alternatively, at least two sensors may be used to generate sensor data on different parts of line 312. The sensor data (in the form of one or more signals) may be transmitted (wired and/or wirelessly) to controller 306. In turn, controller 306 may control DC-to-DC converter 308 (e.g., via one or more commands) in order to generate a current based on the sensed current (e.g., proportional to the sensed current on line 312). DC-to-DC converter 308 may use different types of control loop. A simpler control loop implementation may match (or proportionally match) the current. A more complex control loop in the DC-DC converter may match (or proportionally match) with a predetermined degree of proportional integral differential adjustment.

In this regard, DC-to-DC converter 308 may act as a current source, effectively creating a voltage, with the voltage following the voltage already on the bus (such as on line 312). In one or some embodiments, the electronics may be passive in nature by observing one or more electrical aspects on line 312 (e.g., current and/or voltage) and controlling based on the

### Observed Aspect(s).

As discussed above, the sensed current may be proportionally allocated by DC-to-DC converter 308. Various proportional allocations are contemplated. As one example, the new current (i_{NEW}) may be determined as follows:

i_{NEW}=[E_{new}/(E_{old}+E_{new})]*I_{old}

with proportional-integral-derivative (PID) controller gains associated to align the power over time during transitions. In one or some embodiments, a gain of D pu/min may be used so that at one, some, or each timestep, the difference between current output at that time and current output at the previous timestep was D times the difference between the current output at the previous timestep and the target (I_{NEW}).

In one or some embodiments, various limits may be applied. As one example, a limit may be applied to the power output. In particular, a limit may be applied to the maximum power (Pₘₐₓ) to ensure that the power output of the new battery may always stay below the power rating of the old installation.

Thus, supplemental BESS module 310 includes one or more batteries and one or more output terminals (such as at least one terminal 311 that is electrically connected to at least one power bus, such as line 312) and is configured to supplement the power and energy provided by legacy BESS module 200. The controller 306, in its control, may determine the amount of supplementation. Merely by way of example, the legacy BESS module 200 may comprise a four-hour battery rated for one MW (thereby delivering 4 MW hours). The controller 306, in its control of supplemental BESS module 310, may add a predetermined percentage (e.g., 25%), with the given example resulting in an additional 250 kW, with a total power provided of 1.25 MW. Thus, in one or some embodiments, the controller 306 may control the supplemental BESS module 310 to produce less power than the legacy BESS module 200. Alternatively, the controller 306 may control the supplemental BESS module 310 to produce an equal amount or a greater amount of power than the legacy BESS module 200.

In one or some embodiments, controller 306 may comprise a PID controller that controls the supplemental BESS module 310 in a passive way (e.g., following the sensed current from the legacy BESS module 200 and controlling the supplemental BESS module 310 accordingly).

In one or some embodiments, there may be a delay from sensing the current on line 312 (via sensor 304) to the control by controller 306 of DC-to-DC converter 308 to produce the proportional current, so that there is effectively a delay between the observing/matching of the current. Sufficiently quick control electronics may account for the delay. For example, both of controller 306 and DC-to-DC converter 308 may operate more quickly than PCS 120. In particular, PCSs may typically operate 3-6kHz, whereas may DC-to-DC converters may operate much quicker (e.g., on the order of at least 5 times or 10 times quicker). As such, changes caused by DC-to-DC converter 308 (e.g., in terms of matching) may be sufficiently fast so that PCS 120 does not effectively notice the change.

Moreover, in one or some embodiments, the controls, manifested in one or both of controller 306 or DC-to-DC converter 308, may impose limits as to the amount of power provided by supplemental BESS module 310. The limits may be imposed in one of several ways. In one way, responsive to the sensed voltage, the power output by the supplemental BESS module 310 may be limited. In this regard, various limits, such as various sensed voltages, may result in limits to the power output. Thus, in one or some embodiments, separate from external protections (e.g., an inverter tripping), other protections, such as limiting or ramping down the power may be implemented to avoid unsafe conditions.

FIG. 3B is a second example block diagram 320 for supplementing a legacy battery power system with a supplemental battery power system that is configured to supply supplemental battery capacity. As shown, sensor 304 is configured to sense the current on line 322 (as opposed to line 312 illustrated in FIG. 3A), with line 322 between DC-to-DC converter 202 and DC-to-AC converter 204. In this regard, the sensed current may be sensed in one or more places within the legacy circuit and/or within the grid.

FIG. 3C is a third example block diagram 340 for supplementing a legacy battery power system with a supplemental battery power system. Specifically, FIG. 3C illustrates a plurality of DC-to-DC converters, including DC-to-DC converter 308 and DC-to-DC converter 350. In this regard, the control for the power may be controlled to a much finer degree, including with regard to both the power provided by legacy BESS module 200 (via DC-to-DC converter 350) and the power provided by supplemental BESS module 310 (via DC-to-DC converter 308). In one or some embodiments, current on line 342 is sensed by sensor 304, which may be input to controller 306. In turn, controller 306 may control one or both of DC-to-DC converter 308 and DC-to-DC converter 350. As one example, responsive to the sensed current on line 342, the controller 306 may determine, such as dynamically determine, an amount of power that is to be provided from one or both of legacy BESS module 200 and supplemental BESS module 310. In one particular instance, controller 306 may take a less passive role. Specifically, rather than following the current and/or voltage sensed on line 342, controller 306 may control DC-to-DC converter 350 to draw less power from legacy BESS module 200, effectively placing less burden on legacy BESS module 200. In this way, controller 306 may take a more active role in controlling legacy BESS module 200, such as to extend the usable life of legacy BESS module 200.

FIG. 3D is a fourth example block diagram 360 for supplementing a legacy battery power system with a supplemental battery power system. As discussed above, the supplemental BESS modules may be installed separately, such as in separate stages. For example, FIG. 3D illustrates first supplemental BESS module 370 (with at least one output terminal 371) to Nth supplemental BESS module 372 (with at least one output terminal 373), where N may be any integer number greater than 1. FIG. 3D further illustrates control electronics, including First DC-to-DC converter and controller circuitry 380 (which may comprise a controller and DC-to-DC converter(s) and controller(s)) to Nth DC-to-DC converter and controller circuitry 382. In addition, FIG. 3D illustrates sensor 304 sensing line 362 and inputting the sensed current to the various control electronics in order to control the current generated by the supplemental BESS modules, as discussed above. Thus, in one embodiment, control electronics is assigned to each supplemental BESS module. Alternatively, or in addition, control electronics may be shared between different supplemental BESS modules, such as any two or more supplemental BESS modules.

Thus, various types of controls are contemplated, as illustrated in FIGS. 3A-D. In one or some embodiments, a controller may be assigned to control each respective new DC-to-DC controller added by augmentation. Alternatively; a single dominant controller may be assigned to control each respective new DC-to-DC controller added by augmentation.

Thus, FIG. 3D illustrates a plurality of supplemental BESS modules (see first supplemental BESS module 370 to Nth supplemental BESS module 372) with associated DC-to-DC converter and controller circuitry, which may be installed serially (e.g., at different times based on one or more triggers) or simultaneously. In one or some embodiments, each supplemental BESS module has an associated controller. Alternatively, or in addition, common control may be performed across any two or more supplemental BESS modules. Further, in one or some embodiments, each branch of a respective supplemental BESS module and associated DC-to-DC converter and controller circuitry may have an associated sensor (e.g., to sense one or both of current or voltage for operation of associated DC-to-DC converter and controller circuitry). Alternatively, new branch(es) of may use the same sensor(s) (and the same sensor signals indicative of one or both of current or voltage) from previously installed branches, and may proportionally allocate power control to the later-installed supplemental BESS module(s) based on their relative capacity. In such an instance with common control and/or proportional allocation, the DC-to-DC converters may communicate with one another for operation (e.g., communication between the DC-to-DC converters may indicate that one or more of the branches is inoperative, such as a respective DC-to-DC converter is inoperative, in order to reassign the proportions for allocation to some or all the remaining operative branches).

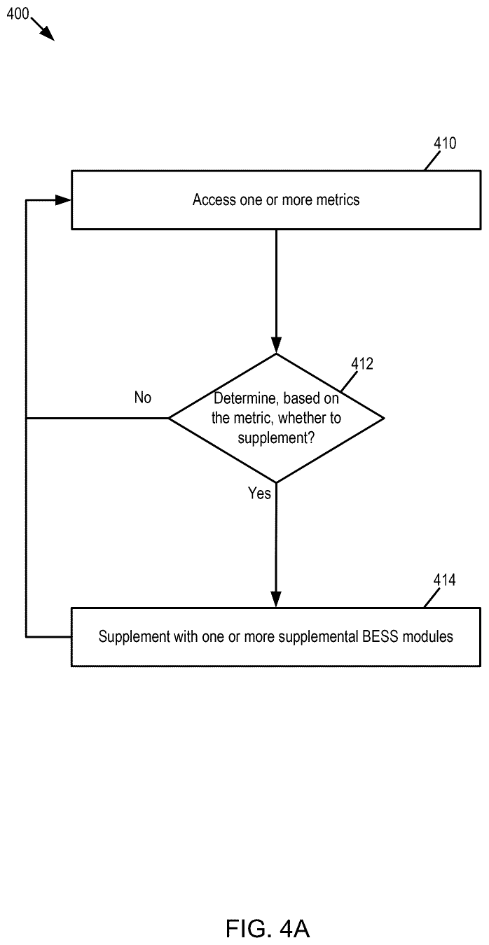

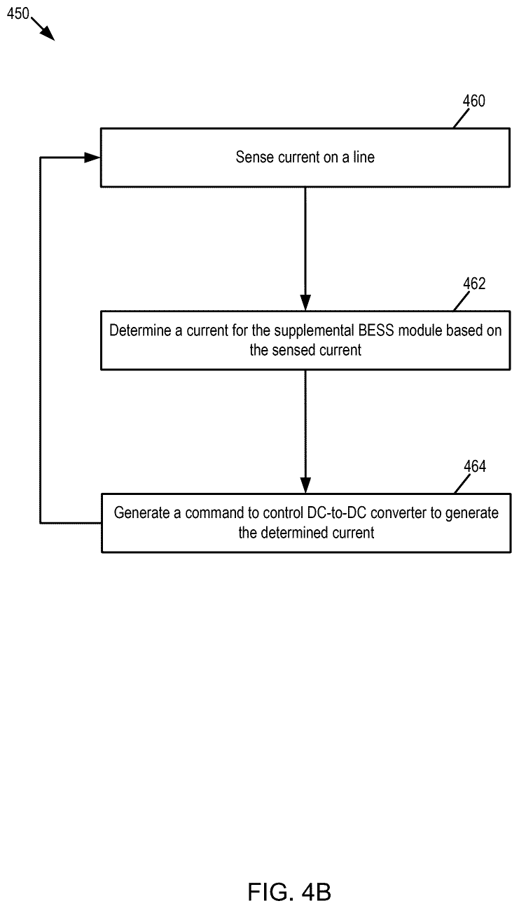

FIG. 4A is an example flow diagram 400 for determining when to supplement with one or more supplemental battery power systems. As discussed above, the timing of supplementing the legacy battery power system may be determined by one or more metrics. In one or some embodiments, the sole metric comprises time, such as the supplemental BESS module(s) being installed at predetermined times since installing of the legacy battery power system. Alternatively, or in addition, the metric may comprise at least one sensed electrical parameter generated by the legacy battery power system, such as any one, any combination, or all of: sensed current output from the legacy battery power system; sensed voltage from the legacy battery power system; or sensed power from the legacy battery power system. In this regard, the timing to supplement the legacy battery power system may be dynamically determined based on the sensed metric (e.g., the sensed degradation of the legacy battery power system).

Thus, at 410, one or more metrics is accessed. At 412, it is determined whether, based on the one or more metrics, to supplement. In the example metric of time, responsive to determining that a predetermined amount of time has passed (e.g., 2 years), it may be determined to supplement. In the example of a sensed electrical parameter, responsive to determining that there is a predefined degradation in the legacy battery power system (e.g., a percentage decrease in the sensed electrical parameter), it may be determined to supplement. Responsive to this determination, at 414, the legacy battery power system is supplemented, such as with one or more supplemental BESS modules.

In one or some embodiments, the determination whether to supplement is based on the load. In particular, certain loads may require a predetermined amount of power for a predetermined amount of time. By way of example, the load may require the equivalent of 2 MW hours (MWh). In the given example, if it is estimated that 20% of the battery capacity will be lost over time, the initial build for the batteries may be 2.5MWh (thereby accounting for the 20% degradation over time). However, this overcapacity is inefficient and expensive. In this regard, it may be more efficient for the initial build to be 2.1 MWh. In such a system, future degradation may be addressed with augmentation as discussed herein. For example, sensing the capacity at a future time after installation of the initial build and determining a predetermined degradation (e.g., at least 4% degradation, which would result in approximately 2.0 MWh being generated by the legacy BESS module) may trigger augmentation. In such an instance, the augmentation may be performed at a future time (e.g., after at least 2 years), likely resulting in two things: (1) batteries in the future time will be less expensive; and (2) there is a benefit from the time value of money. Further, the amount of augmentation may be tailored, accounting for the estimated future degradation. In the given example, the augmentation may add 0.4 MWh, effectively providing an additional 0.4 MWh of degradation to the legacy BESS module and to the supplemental BESS module prior to an additional supplementation. Again, in the given example, if the system maintains the power level (e.g., remain at 2 MWh), control of the supplemental BESS module may make the addition proportional to the capacity added (e.g., adding 0.4 MWh to 2.0 MWh would be 0.4/2.4 is the proportion of power that is essentially delivered). In this regard, such a configuration may reduce degradation of the legacy BESS module since the legacy BESS module may be used more lightly than prior to installation of the supplemental BESS module.

FIG. 4B is an example flow diagram 450 for operating the legacy battery power system and the supplemental battery power system(s). At 460, the current may be sensed on one or more lines, such as discussed above. At 462, the current for the supplemental BESS module may be determined based on the sensed current (e.g., a percentage of the sensed current). At 464, the controller generates a command to control DC-to-DC converter to generate the determined current. In this regard, the controller is configured to set at least one electrical parameter (e.g., one or both of current or voltage) based on a determined electrical parameter. In one or some embodiments, the controller may determine the electrical parameter by sensing the electrical parameter and/or by communicating with the PCS. Further, in one or some embodiments, the controller may determine the setting of one or more electrical parameters for the supplemental BESS module based on the determined electrical parameter (which may be sensed). As one example, the controller may control the current generated by the supplemental BESS module based on a predefined setting (e.g., the current generated by the supplemental BESS module is proportional to the current sensed). As another example, the controller may dynamically control the current generated by the supplemental BESS module so that the current changes over time. In one or some embodiments, the predefined setting of the controller may be pre-programmed. Alternatively, or in addition, the predefined setting may be responsive to a communication received by the controller, such as based on a communication with the PCS. Further, in one or some embodiments, the controller may control the voltage generated by the supplemental BESS module to be identical to the voltage generated by the legacy BESS module.

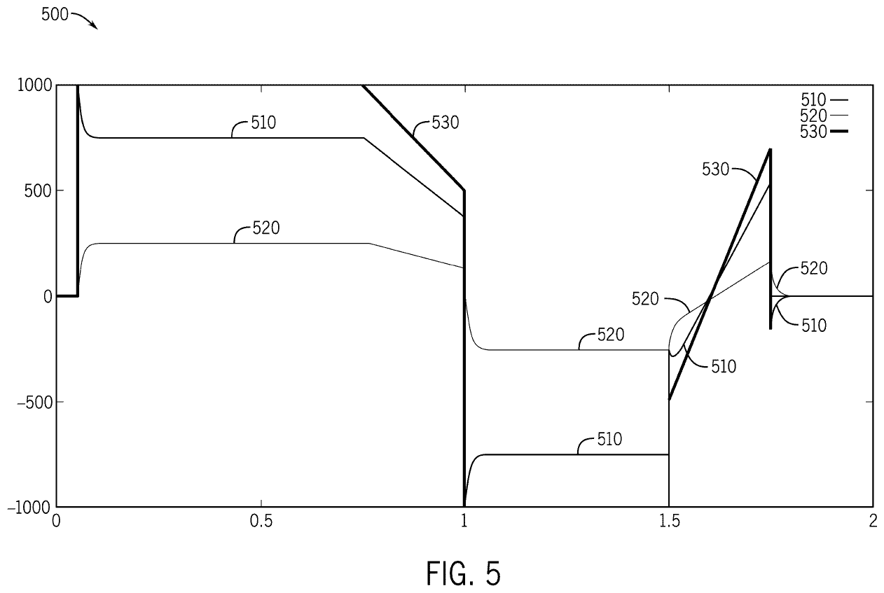

FIG. 5 is a graph 500 of power supplied versus time. Curve 510 comprises the power contribution of the legacy BESS module, curve 520 comprises the power contribution of the supplemental BESS module, and curve 530 comprises the power contribution of both the legacy BESS module and the supplemental BESS module. As shown in FIG. 5, after a predetermined amount of time, power is stepped up to 1 MW, being held constant, ramped down to 500 kW, and then dropped to −1000 kW (thereby charging). FIG. 5 further illustrates a delay being imposed (which is a proportional gain on the response). Further, in one or some embodiments, the legacy BESS module takes a leading role with the supplemental BESS module following. In this way, the supplemental BESS module may alleviate the burden so that the legacy BESS module does not bear the entire cost of sourcing the power. As discussed above, the supplemental BESS module may more quickly follow, such as by using a PID controller (wherein the gain is tuned on the PID loop), essentially ensuring that changes are met without excessive overshooting. Thus, an advanced control algorithm may allow for the appearance (at least with regard to the PCS) of an instantaneous response from the supplemental BESS module.

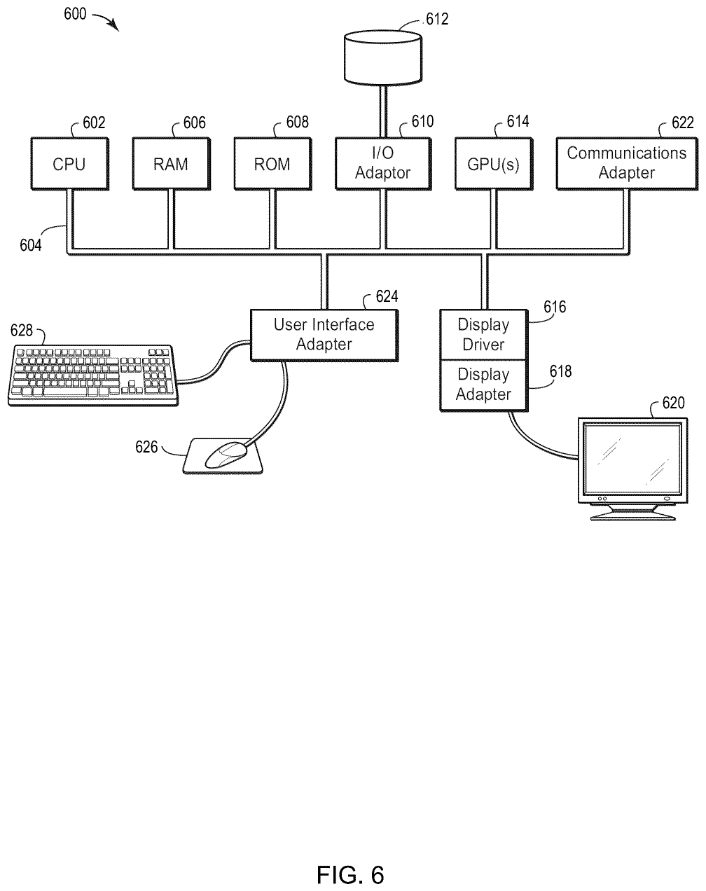

In all practical applications, the present technological advancement must be used in conjunction with a computer, programmed in accordance with the disclosures herein. Merely by way of example, various devices disclosed in the present application may comprise a computer or may work in combination with a computer (e.g., executed by a computer), such as, for example, in FIGS. 1, 2, and 3A-D. As such, computing functionality may be resident within any of the electronic devices discussed herein. Merely by way of example, FIG. 6 is a diagram of an exemplary computer system 600 that may be utilized to implement methods, including the flow diagrams, described herein. A central processing unit (CPU) 602 is coupled to system bus 604. The CPU 602 may be any general-purpose CPU, although other types of architectures of CPU 602 (or other components of exemplary computer system 600) may be used as long as CPU 602 (and other components of computer system 600) supports the operations as described herein. Those of ordinary skill in the art will appreciate that, while only a single CPU 602 is shown in FIG. 6, additional CPUs may be present. Moreover, the computer system 600 may comprise a networked, multi-processor computer system that may include a hybrid parallel CPU/GPU system. The CPU 602 may execute the various logical instructions according to various teachings disclosed herein. For example, the CPU 602 may execute machine-level instructions for performing processing according to the operational flow described herein.

The computer system 600 may also include computer components such as non-transitory, computer-readable media. Examples of computer-readable media include computer-readable non-transitory storage media, such as a random-access memory (RAM) 606, which may be SRAM, DRAM, SDRAM, or the like. The computer system 600 may also include additional non-transitory, computer-readable storage media such as a read-only memory (ROM) 608, which may be PROM, EPROM, EEPROM, or the like. RAM 606 and ROM 608 hold user and system data and programs, as is known in the art. In this regard, computer-readable media may comprise executable instructions to perform any one, any combination, or all of the blocks in the flow chart in FIG. 4. The computer system 600 may also include an input/output (I/O) adapter 610, a graphics processing unit (GPU) 614, a communications adapter 622, a user interface adapter 624, a display driver 616, and a display adapter 618.

The I/O adapter 610 may connect additional non-transitory, computer-readable media such as storage device(s) 612, including, for example, a hard drive, a compact disc (CD) drive, a floppy disk drive, a tape drive, and the like to computer system 600. The storage device(s) may be used when RAM 606 is insufficient for the memory requirements associated with storing data for operations of the present techniques. The data storage of the computer system 600 may be used for storing information and/or other data used or generated as disclosed herein. For example, storage device(s) 612 may be used to store configuration information or additional plug-ins in accordance with the present techniques. Further, user interface adapter 624 couples user input devices, such as a keyboard 628, a pointing device 626 and/or output devices to the computer system 600. The display adapter 618 is driven by the CPU 602 to control the display on a display device 620 to, for example, present information to the user such as images generated according to methods described herein.

The architecture of computer system 600 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 600 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

What is claimed is:

1. A power storage system comprising:
a legacy battery energy storage system (BESS) module, the legacy BESS module including at least one battery and at least one output terminal electrically connected to at least one power bus;
a supplemental BESS module configured to supplement power to the at least one power bus, the supplemental BESS module including at least one supplemental battery and at least one output terminal;
at least one converter electrically coupled between the at least one output terminal of the supplemental BESS module and the at least one power bus; and
at least one controller configured to:
determine at least one electrical parameter set by at least one power control system (PCS) for the at least one power bus; and
control the at least one converter in order to generate at least one output based on the at least one electrical parameter set on the at least one power bus set by the at least one PCS.

2. The power storage system of claim 1, wherein the at least one electrical parameter comprises current; and
wherein the at least one controller is configured to control the at least one converter in order to generate at least one output current based on the current on the at least one power bus set by the at least one PCS and a voltage that follows a voltage on the at least one power bus.

3. The power storage system of claim 1, wherein the at least one controller is configured to determine the at least one electrical parameter by a sensed current on the at least one power bus.

4. The power storage system of claim 3, wherein the at least one controller is configured to control the at least one converter to generate the at least one output current to be proportional to the sensed current on the at least one power bus.

5. The power storage system of claim 3, wherein the at least one controller is configured to dynamically control the at least one converter to generate the at least one output current.

6. The power storage system of claim 5, wherein the at least one controller is configured to dynamically control the at least one converter to generate the at least one output current so that, over time, the at least one controller controls the at least one output current to be a different proportion of the sensed current.

7. The power storage system of claim 3, wherein the legacy BESS module includes a legacy battery capacity;
wherein the supplemental BESS module includes a supplemental battery capacity; and
wherein the at least one controller is configured to control the at least one output current of the at least one converter in proportion to a ratio between the supplemental battery capacity of the supplemental BESS module and the legacy battery capacity of the legacy BESS module.

8. The power storage system of claim 1, wherein the at least one controller is configured to determine the at least one electrical parameter by communicating with the at least one PCS.

9. The power storage system of claim 1, wherein the at least one power bus is electrically connected to an input of the at least one PCS;
wherein the supplemental BESS module is configured to augment power generated by the legacy BESS module to the at least one PCS; and
wherein the controller is configured to control the at least one converter so that the at least one PCS unable to detect the supplemental BESS module after electrical connection of the supplemental BESS module to the at least one power bus and after the supplemental BESS module provides power to the at least one power bus.

10. The power storage system of claim 1, wherein the at least one converter comprises a DC-DC converter operated as a current source.

11. A method for supplying power from a legacy battery energy storage system (BESS) module and a supplemental BESS module that is later-installed than the legacy BESS module, wherein the legacy BESS module including at least one battery and at least one output terminal electrically connected to at least one power bus, and wherein the supplemental BESS module including at least one supplemental battery and at least one output terminal, the method comprising:
determining at least one electrical parameter set by at least one power control system (PCS) for the at least one power bus; and
controlling at least one converter in order to generate at least one output based on the at least one electrical parameter set on the at least one power bus set by the at least one PCS, the at least one converter electrically coupled between the at least one output terminal of the supplemental BESS module and the at least one power bus.

12. The method of claim 11, wherein the at least one electrical parameter comprises current; and
wherein controlling the at least one converter generates at least one output current based on the current on the at least one power bus set by the at least one PCS and a voltage that follows a voltage on the at least one power bus.

13. The method of claim 11, wherein determining the at least one electrical parameter is by sensing current on the at least one power bus.

14. The method of claim 13, wherein controlling the at least one converter generates the at least one output current to be proportional to the sensed current on the at least one power bus.

15. The method of claim 13, wherein the at least one controller is dynamically controlled in order to generate the at least one output current.

16. The method of claim 15, wherein dynamically controlling the at least one converter generates the at least one output current so that, over time, the at least one controller controls the at least one output current to be a different proportion of the sensed current.

17. The method of claim 13, wherein the legacy BESS module includes a legacy battery capacity;
wherein the supplemental BESS module includes a supplemental battery capacity; and
wherein controlling the at least one output current of the at least one converter is in proportion to a ratio between the supplemental battery capacity of the supplemental BESS module and the legacy battery capacity of the legacy BESS module.

18. A method for supplementing power from a legacy battery energy storage system (BESS) module with a supplemental BESS module that is later-installed than the legacy BESS module, wherein the legacy BESS module including at least one battery and at least one output terminal electrically connected to at least one power bus, and wherein the supplemental BESS module including at least one supplemental battery and at least one output terminal, the method comprising:
accessing one or more metrics;
determining, based on the one or more metrics, whether to supplement the legacy BESS module with the supplemental BESS module; and
responsive to determining to supplement the legacy BESS module with the supplemental BESS module, supplementing the legacy BESS module with the supplemental BESS module so that the supplemental BESS module augments power generated by the legacy BESS module to at least one PCS without the at least one PCS being able to detect the supplemental BESS module after electrical connection of the supplemental BESS module to the at least one power bus and after the supplemental BESS module provides power to the at least one power bus.

19. The method of claim 18, wherein the one or more metrics are indicative of degradation of at least one aspect of the legacy BESS module.

20. The method of claim 19, wherein determining whether to supplement the legacy BESS module with the supplemental BESS module and supplementing the legacy BESS module with the supplemental BESS module is performed iteratively so that the legacy BESS module is sequentially supplemented over a usable life of the legacy BESS module.
